(19) United States
(12) Patent Application Publication
(10) Pub. No.: US 2025/0387770 A1
(43) Pub. Date: Dec. 25, 2025

(54) Composite solar-control coating based on tungsten bronze nanocrystals dispersed in a silica-based sol-gel matrix

(71) Applicants: ECOLE POLYTECHNIQUE, Palaiseau (FR); Centre National De La Recherche Scientifique, Paris (FR)

(72) Inventors: Louise DAUGAS, Palaiseau Cedex (FR); Jongwook KIM, Palaiseau Cedex (FR); Khalid LAHLIL, Palaiseau Cedex (FR); Thierry GACOIN, Palaiseau Cedex (FR)

(21) Appl. No.: 18/879,608

(22) PCT Filed: Jun. 27, 2023
(86) PCT No.: PCT/EP2023/067524

§ 371 Date: Dec. 27, 2024

(30) Foreign Application Priority Data
Jun. 28, 2022 (FR) FR2206423

(51) Int. Cl. B01J 13/00; C01G 41/02; C03C 17/00

(52) U.S. Cl. CPC B01J 13/0047; C01G 41/02; C03C 17/007; C01P 2002/01; C01P 2002/54; C01P 2002/72; C01P 2002/82; C01P 2002/84; C01P 2002/88; C01P 2004/03; C03C 2217/242; C03C 2217/475; C03C 2217/48; C03C 2217/74; C03C 2218/112; C03C 2218/113; C03C 2218/116

(57) ABSTRACT

The invention relates to a sol formulation which can be used to form a solar-control coating, in particular a coating that blocks UV and NIR radiation, comprising at least: one or more silica-based sol-gel matrix precursors, and doped tungsten bronze nanocrystals which are dispersed uniformly and individually in a protic solvent medium. The invention also relates to a method for forming a solar-control coating at the surface of a support using such a sol formulation, and also to a structure comprising at least one support, preferably a transparent support, having such a solar-control coating on at least one face thereof.

### TECHNICAL FIELD

The present invention relates to the field of developing coatings for solar control, allowing different ranges of solar radiation to be filtered out effectively. The invention relates more particularly to the formation of a coating, based on plasmonic nanocrystals of the tungsten bronze type, having improved optical performance, in particular allowing ultraviolet and/or near infrared rays to be blocked efficiently. These coatings may be used in a variety of applications, for example they may be used in glazing.

### PRIOR ART

The development of glazing materials which, while remaining transparent, have protection properties against ultraviolet (UV) radiation and/or near infrared (NIR) radiation, is attracting growing interest for a wide range of applications, in particular in the context of manufacturing windows for buildings, for vehicles, greenhouses in the agricultural sector, etc.

Specifically, of all the rays contained in sunlight, ultraviolet (UV) rays are undesirable, since they are capable of causing damage to human skin and to accessories or equipment inside or on board vehicles, while near-infrared (NIR) rays cause a significant rise in internal temperature.

In particular, in today's context where energy-efficient building renovation is becoming a major environmental and technological challenge, the development of solar-control glazing, i.e. glazing that enables the various wavelength ranges of solar radiation to be filtered out, is seen as an important technological lever for limiting heating and air-conditioning energy consumption. Thus, when the weather is cold, it is important to be able to store the heat created by heating appliances inside a room or vehicle, generally in the mid-infrared (MIR) range between 3 and 18 μm [1]. On the other hand, when the weather is hot, it is a matter of being able to block out the near-infrared radiation of the solar emission, located in the wavelength range from 780 to 2500 nm, and representing 50% of solar radiation.

Thus, it is desirable for glazings not only to have good transparency properties, in other words at least partial transmission of radiation in the visible range (noted Vis) of sunlight, but also be able to block the ultraviolet and near-infrared radiation ranges, so as to protect and thermally insulate the interior.

Several coating technologies for glazing, for example windows, windscreens, verandas and greenhouses, have already been proposed for blocking ultraviolet and/or near-infrared radiation. The most commonly used thermal screens are based on metallic layers or low-emissivity coatings that effectively reflect MIR [2]. However, to efficiently block NIR, it is necessary to use complex stacking structures of several functional layers. These approaches are unfortunately expensive, typically at least 10 times more expensive than the cost of uncoated glass, and generally allow selectivity to be achieved in terms of wavelength transmission/extinction (which can be assessed by the T_{Vis}:T_{UV} and T_{Vis}:T_{NIR} ratios between transmission in the visible wavelength range (T_{Vis}) and transmission in the UV and NIR wavelength ranges respectively (T_{UV} and T_{NIR})).

“Plasmonic” particles, which have high absorption for a small amount of material (high optical density) and very high selectivity in their absorption wavelength range, are emerging as a promising solution for NIR protection.

Conventional metals, such as silver and gold, have a high density of free carriers (10²² cm⁻³) which, when confined to the nanometric scale, lead to the collective oscillation of their free electrons, known as localized surface plasmon resonance (LSPR). The phenomenon of metallic LSPR has been extensively studied over the last few decades, and has applications in a wide variety of optical fields ([3]). However, the range of their absorption is limited to the ultraviolet and visible ranges, leaving the NIR range mostly inaccessible for metals, with the exception of complex architectures such as highly anisotropic core-shell nanowires ([4]).

In this context, highly doped semiconductor nanocrystals are attracting growing interest as absorbent materials [5]. Their free carrier density may be adjusted from 10¹⁸ to 10²² cm⁻³ by modifying their doping level ([6]), directly during synthesis ([7]), or by subsequent treatments (post-treatments) ([8]). This tool, added to known parameters for metals such as shape, size or surrounding media, and to the numerous composition possibilities, allows extremely precise control of their LSPR position, from visible to mid-infrared (MIR) [9]. Consequently, their unique features are being exploited for numerous applications, for example in LSPR detection ([10]); bio-imaging and therapy ([11]); and the development of smart windows [12]. In particular, semiconductor nanocrystals, allowing high absorption in the NIR, while at the same time retaining transparency in the visible range, are thus seen as good candidates for obtaining coatings for solar control.

In particular, numerous studies use indium tin oxide (ITO) or aluminum-doped zinc oxide (AZO) nanoparticles to produce active or passive devices ([13]). However, their LSPR, located in the 1500-2500 nm wavelength region, leaves high radiation transmission in the 780-1500 nm wavelength range.

More recently, the development of novel nanocrystalline compositions, such as rare-earth metal hexaborides (RB₆, R═La, Ce, Pr, Nd, Gd) ([14]), and tungsten bronzes (MₓWO₃, M=K, Na, Cs) ([15], [16], [17], [18], [19]) have allowed LSPR, and thus radiation absorption, to be achieved in the NIR wavelength range.

Unfortunately, incorporating these nanocrystals into solid thin films, without degrading their LSPR intensity and selectivity, remains a challenge. Specifically, in the context of using these nanocrystals in conventional processes for forming surface coatings, a coupling effect linked to the connection of the nanocrystals to each other at the level of the compact film structure causes a decrease in LSPR intensity and a red shift, while aggregation of the nanocrystals within the coatings formed leads to an increase in scattering in the visible range ([20]).

Among the methods proposed for preparing semiconductor nanocrystal-based coatings, mention may be made of the publication by Zeng et al which describes the manufacture of thin films of composite resin incorporating Cs_{0.33} WO₃ nanoparticles prepared by bulk grinding methods, offering limited control over their sizes and shapes. Mention may also be made of the publication by T. Mattox et al [14], which proposes a means of dispersing colloidal LaB₆ in a polymer or sol-gel silica matrix by incorporating ligands during the solvent-based synthesis of sodium borohydride. However, this methodology cannot be applied to most plasmonic metal oxide semiconductors, whose synthetic routes use organometallic complex precursors that react at high temperatures in nonpolar solvents. By modifying various parameters, these syntheses allow precise control of particle size and shape, but leave them capped with nonpolar ligands, which makes them difficult to disperse in the majority of polymers or silica media.

The need thus remains for a means of exploiting the advantageous optical properties of plasmonic nanocrystals of the tungsten bronze type when they are used on a surface coating.

More particularly, the need remains for a method for producing a coating based on plasmonic nanocrystals of the tungsten bronze type, without impairing the properties of these nanocrystals, in particular while maintaining high radiation extinction in the UV and NIR ranges, while at the same time maintaining good transparency in the visible range.

The invention is specifically directed toward meeting these needs.

### DESCRIPTION OF THE INVENTION

The present invention thus proposes a means for affording a thin-film coating based on doped tungsten bronze nanocrystals, without degrading the intrinsic properties of these nanocrystals, in particular in terms of the intensity and selectivity of their LSPR, and thus allowing the formation of a solar-control coating which shows high radiation extinction in the UV and NIR ranges, while at the same time maintaining high transparency in the visible range.

More particularly, the inventors have discovered that a coating with the required optical properties, which is in particular capable of effectively blocking UV and near-infrared radiation, can be afforded by dispersing doped tungsten bronze nanocrystals, preferably of controlled morphology and size, in a homogeneous and individualized manner within a silica-based sol-gel matrix.

Such a composite coating for solar control can more particularly be produced from a sol formulation comprising a mixture of one or more precursors of said silica-based sol-gel matrix and of said doped tungsten bronze nanocrystals, homogeneously and individually dispersed in a protic solvent medium.

Thus, according to a first of its aspects, the present invention relates to a sol formulation, which is useful for forming a solar-control coating, in particular a coating for blocking UV and NIR radiation, said sol formulation comprising at least:
one or more silica-based sol-gel matrix precursors, and
nanocrystals of the type MₓWO_{3-y}, with M representing potassium (K), sodium (Na) or cesium (Cs), x ranging from 0.05 to 0.33 and y from 0 to 0.4, referred to as doped tungsten bronze nanocrystals, homogeneously and individually dispersed in a protic solvent medium.

Preferably, as detailed in the text hereinbelow, the doped tungsten bronze nanocrystals are advantageously surface-functionalized, so as to promote their dispersion within said sol formulation and within the composite coating formed therefrom.

The nanocrystals may preferably be functionalized with at least one ligand that is capable of promoting good dispersion of said nanocrystals within the sol formulation.

Such ligands may be, for example, those bearing hydroxyl functions, for example polyglycerol ligands, in particular of the hyperbranched polyglycerol type, or else polyphosphate or organofunctional silane ligands, such as gamma-glycidoxypropyltrimethoxysilane (GLYMO) and (3-aminopropyl)triethoxysilane (APTES), in particular said ligand(s) possibly being hyperbranched polyglycerols.

According to another of its aspects, the invention also relates to the use of a sol formulation according to the invention for forming a solar-control coating, which in particular blocks UV and NIR radiation, on the surface of a support, in particular on the surface of a transparent support and more particularly of a support made of glass or transparent polymer(s).

In particular, the invention relates to a process for forming a solar-control coating, in particular which blocks UV and NIR radiation, on the surface of a support, notably on the surface of a glass or transparent polymer support, comprising at least the steps consisting in:
(i) providing a sol formulation according to the invention, comprising one or more silica-based sol-gel matrix precursors and doped tungsten bronze nanocrystals, preferably surface-functionalized with at least one ligand as defined previously, in particular ligands bearing hydroxyl functions, said nanocrystals being homogeneously and individually dispersed in a protic solvent medium;
(ii) depositing a layer of said sol formulation on the surface of said support; and
(iii) drying the layer formed in step (ii) so as to obtain said silica-based sol-gel matrix.

According to another of its aspects, the invention relates to a structure comprising at least one support, which is preferably transparent, in particular made of glass or transparent polymer(s), having on at least one of its faces a solar-control coating, in particular which blocks UV and NIR radiation, formed from a sol formulation according to the invention as defined previously, and more particularly via a process according to the invention as defined previously. Such a coating more particularly comprises a silica-based sol-gel matrix in which doped tungsten bronze nanocrystals are homogeneously dispersed in an individualized manner.

In the context of the present invention, the terms “nanocrystals dispersed in an individualized manner or individually”, and “nanocrystals that are individualized”, within a given medium, for example within a sol formulation or coating, are intended to denote the fact that the nanocrystals are not aggregated, in other words they are not present in the form of aggregates. In particular, the distance between two individualized nanocrystals is strictly greater than their largest dimension, in particular at least once as great as their largest dimension.

The assembly of nanocrystals under consideration according to the invention (in terms of the dispersion or coating formed) may optionally contain nanocrystals which do not comply with this feature, provided that the non-aggregation criterion is met by at least 60% by number, in particular at least 70% by number, of the nanocrystals of the assembly. Preferably, at least 80%, in particular at least 90%, preferably at least 95% by number of the nanocrystals in the assembly under consideration are individualized.

The term “homogeneous” means that the nanocrystals are uniformly spread throughout the volume of the dispersion or coating formed, on a scale of about a hundred nanometers. The homogeneity of the nanocrystal dispersion within the coating formed according to the invention can be assessed as detailed in the following examples, by analyzing images obtained by 3D tomographic transmission electron microscopy, in particular using the Voronoi cell algorithm.

As illustrated in the examples that follow, the inventors have found that the intrinsic optical properties of the doped tungsten bronze nanocrystals, in particular in terms of the intensity and position of their LSPR, are advantageously preserved within the hard, protective silica-based sol-gel matrix.

Advantageously, the optical properties of the coating can thus be readily modulated, in particular the extinction selectivity in the UV and NIR ranges, by controlling the composition of the nanocrystals used, in particular their level of doping, size and morphology.

Thus, as indicated previously, doped tungsten bronze nanocrystals may simultaneously have a localized surface plasmon resonance (LSPR), strongly absorbing NIR radiation, and also strong absorption of UV radiation by virtue of their bandgap energy at the visible-UV boundary.

The term “ultraviolet radiation” is intended to denote the part of the electromagnetic spectrum within the wavelength range from 200 nm to 390 nm, while the term “near-infrared radiation” is intended to denote the part of the electromagnetic spectrum within the wavelength range from 780 nm to 2500 nm. The visible spectrum means the part of the electromagnetic spectrum in the wavelength range from 390 nm to 780 nm.

Advantageously, the doped tungsten bronze nanocrystals used have a controlled size and morphology so as to adjust the spectral position of their localized surface plasmon resonance (LSPR) peak, and thus their NIR absorption selectivity.

It is also possible to vary the degree of alkali-metal doping of the tungsten bronze nanocrystals used, so as to control the position of the bandgap absorption in the UV range.

Thus, it is possible to afford a coating with optimized optical properties, in particular effective blocking of UV and NIR radiation, by adjusting the intrinsic properties of the nanocrystals used. The ability of the coating to act as a screen to UV and NIR radiation may be evaluated, as detailed in the examples that follow, by measuring the extinction spectra of the films, for example using a spectrophotometer.

In particular, the coating may have an NIR absorption percentage, noted A_{NIR}, of greater than or equal to 60%, in particular greater than or equal to 70%, and/or a solar energy transmission selectivity, known as “SETS”, of greater than or equal to 0.70, in particular greater than or equal to 0.75.

The solar energy transmittance selectivity (SETS) [18], and also the percentage of NIR absorption (A_{NIR}), can be calculated from the convolution of the extinction spectra of a film with solar radiation, for a transmittance with respect to the visible range set at 80%.

In particular, the NIR absorption percentage is defined as follows [29]:

$${A}_{NIR , solar} = ( 1 - \frac{{\int }_{780}^{2500} {I}_{NC} ( λ ) d λ}{{\int }_{780}^{2500} {I}_{solar} ( λ ) d λ} ) \cdot 100$$

with I_{NC} representing the irradiance after filtering through a medium containing the nanocrystals, in particular through the coating, Iₛₒₗₐᵣ representing the irradiance of the sun, and λ representing the wavelength.

In particular, the solar energy transmission selectivity is defined as follows [29]:

$$SETS = \frac{1}{2} ( 1 + \frac{{\int }_{380}^{780} {I}_{NC} ( λ ) d λ}{{\int }_{380}^{780} {I}_{solar} ( λ ) d λ} - \frac{{\int }_{780}^{2500} {I}_{NC} ( λ ) d λ}{{\int }_{780}^{2500} {I}_{solar} ( λ ) d λ} )$$

with I_{NC}, Iₛₒₗₐᵣ and λ being as defined above.

Moreover, the coating has high transparency and an esthetically favorable color in the visible range. In particular, the coating formed advantageously has a transmittance, over the entire visible spectrum, of greater than or equal to 70%, in particular greater than or equal to 80%, notably greater than or equal to 90% and more particularly greater than or equal to 95%.

The transmittance represents the light intensity passing through said coating in the visible spectrum. It may be measured, for example, by UV-Vis spectrometry, for example using a Shimadzu UV-3100 spectrometer.

Moreover, advantageously, the coating obtained according to the invention has a homogeneous, individualized dispersion of the doped tungsten bronze nanocrystals within the silica-based sol-gel matrix, even at high nanocrystal volume fractions, in particular up to 20%.

It is thus possible to obtain a coating with optimized solar control properties, which in particular screens out both UV and NIR radiation, while at the same time maintaining good transparency in the visible range.

The invention thus relates, according to another of its aspects, to the use of a sol formulation according to the invention for conferring solar control properties on a support, in particular for screening out UV and NIR radiation.

Moreover, the formation of a coating according to the invention proves to be simple and inexpensive, in particular compared to the coating technologies proposed to date, as discussed previously, based on complex stacks of metal layers. The reason for this is that the coating according to the invention can be produced via conventional liquid-phase deposition techniques, for example by spin-coating.

Finally, the composite coating formed according to the invention, in particular in the form of a thin film, notably with a thickness of less than 3 μm, has good mechanical properties, notably in terms of film flexibility and resistance to fracturing.

Also, the coating formed according to the invention, based on chemically/thermally stable inorganic oxides, has good durability, in particular a durability superior to that of the coatings already proposed in the prior art based on organic polymers or metallic deposits.

The coatings formed according to the invention, having optimized solar control properties, may find a wide range of applications. They may be used, for example, for glazing, for example for building windows, notably to reduce energy consumption in eco-buildings, for vehicle glazing, for example for motor vehicles, for greenhouses in agriculture, for technical glasses, etc.

According to another of its aspects, the invention thus relates to an article comprising at least one structure as defined previously, said article notably being a glazing, for example for building windows, verandas, portholes, motor vehicle windscreens, train glazing, greenhouses used in agriculture or else photovoltaic panels.

Other features, variants and advantages of a coating according to the invention, its preparation and its properties, will become clearer on reading the description, examples and figures that follow, which are given as nonlimiting illustrations of the invention.

In the text hereinbelow, the expressions “between . . . and . . . ”, “ranging from . . . to . . . ” and “varying from . . . to . . . ” are equivalent and are intended to mean that the limits are included, unless otherwise mentioned.

### BRIEF DESCRIPTION OF THE DRAWINGS

FIG. 1a shows the morphology of the nanocrystals synthesized in Example 1.1, having different aspect ratios (figure a) to d)) and the associated UV-vis-NIR extinction spectra (figure e)).

FIG. 1b is a transmission electron microscopy (TEM) photograph of the CsₓWO_{3-y} nanocrystals synthesized according to Example 1.2 (FIG. 1b(i)); and the histogram of the nanocrystal size distribution (FIG. 1b(ii));

FIG. 2 is the X-ray diffraction (XRD) spectrum of the nanocrystals synthesized in Example 1.2 and in gray the reference spectrum of Cs_{0.32}WO₃ (JCPDS 1524692);

FIG. 3 shows the extinction spectra of nanocrystals, according to Example 2, in an aggregated state when surface-functionalized with oleic acid or in a dispersed state when functionalized with DMOAP, at the same concentration;

FIG. 4 is the SEM image of the cross-section of the NC@DMOAP film obtained in Example 2 on a silicon substrate;

FIG. 5 shows the evolution of the extinction coefficient (in μm⁻¹) and irradiance (W·m⁻²·nm⁻¹) of nanocrystals dispersed in solution and in the film prepared in Example 2, and their convolution with solar emission;

FIG. 6 shows the extinction, reflectance and absorbance spectra of the film prepared in Example 2;

FIG. 7 schematically represents the preparation of nanocrystals surface-functionalized with polyglycerol and their use in a silica sol-gel matrix, as described in Example 3;

FIG. 8 shows the Fourier Transform Infrared (FTIR) spectra of nanocrystals after synthesis according to Example 1.2, after surface functionalization with polyglycerol ligands according to Example 3 and after insertion in a TMOS:MTMOS matrix;

FIG. 9 is a thermogravimetric analysis of the nanocrystals surface-functionalized with polyglycerol, synthesized in Example 3;

FIG. 10 is a photograph of the sample of solution of the nanocrystals surface-functionalized with polyglycerol, prepared in Example 3, dispersed in methanol;

FIG. 11 represents a TEM photograph of the solution of nanocrystals surface-functionalized with polyglycerol, prepared in Example 3, dispersed in methanol (FIG. 11(a)) and the histogram of the nanocrystal size distribution (FIG. 11(b));

FIG. 12 shows TEM projections at an angle of 0° C. of the FIB-reduced films formed in Example 4, with nanocrystal volumetric fractions of 2.7% (FIGS. 12(a)) and 1.1% (FIG. 12(b)). The insets show the Fast Fourier Transform (FFT);

FIG. 13 shows the 3D modelling of nanocrystals in the silica matrix, with nanocrystal volumetric fractions of 2.7% (FIGS. 13(a)) and 1.1% (FIG. 13(b));

FIG. 14 shows the comparison of the distribution of the number of nearest neighbors of each nanocrystal, noted N_{neighbors} between experiments and simulations, for the composite coatings formed in Example 4 with different nanocrystal volumetric fractions;

FIG. 15 shows the comparison of nearest neighbor distance, noted d_{N-N} between experiment and simulation, for the composite coatings formed in Example 4 with different nanocrystal volumetric fractions;

FIG. 16 shows normalized UV-vis-NIR extinction spectra of composite thin films with different nanocrystal volumetric fractions in the composite coatings;

FIG. 17 shows the absorbance value divided by the optical path length as a function of the nanocrystal volumetric fraction in the composite coatings; and

FIG. 18 shows the optical properties of a 6.0 μm thick coating with a nanocrystal volumetric fraction of 1.1%.

FIG. 19 shows the extinction spectrum over time of a coating covered with a protective layer, as prepared in Example 6.

### DETAILED DESCRIPTION

### Doped Tungsten Bronze Nanocrystal

The nanocrystals used according to the invention are doped metal oxide nanocrystals, known as doped tungsten bronzes, of the type MₓWO_{3-y}, with M representing potassium (K), sodium (Na) or cesium (Cs), x ranging from 0.05 to 0.33 and y from 0 to 0.4.

It is understood that the coating formed according to the invention may use a single type of nanocrystal or a mixture of at least two different nanocrystals.

In a particular embodiment, the nanocrystals are cesium-doped tungsten bronze nanocrystals, in other words nanocrystals of the abovementioned formula in which M is cesium.

Advantageously, the nanocrystals are monocrystalline.

Advantageously, as mentioned previously, the features of the MₓWO_{3-y} nanocrystals, in particular in terms of composition, notably the density of free charge carriers, morphology and size, are controlled and adjusted so as to achieve the desired UV and NIR absorption selectivities.

In particular, the degree of alkali metal, for example cesium, doping of the doped tungsten bronze nanocrystals used according to the invention may be adjusted with respect to the desired UV bandgap position, to obtain the desired UV wavelength absorption selectivity.

In particular, the degree of doping with alkali metal, in particular cesium, may comprise between 0.05 and 0.33 and/or the free carrier density may be between 1×10¹⁸ and 9×10²² cm.⁻³

Advantageously, the nanocrystals have a controlled morphology, in particular a controlled shape and size, so as to adjust the spectral position of their localized surface plasmon resonance (LSPR) peak, and to obtain optimized NIR wavelength absorption selectivity.

Preferably, they are in the form of nanorods. They may have an aspect ratio ((AR), defined as the ratio of the longest dimension of the particle to its shortest dimension) of between 0.1 and 20, in particular between 0.4 and 12. In particular, they may have an aspect ratio of between 1.2 and 20, more particularly between 1.2 and 3.5, notably between 1.5 and 2.5.

They have a length preferably between 4 nm and 100 nm and a width preferably between 5 nm and 100 nm, in particular between 5 nm and 30 nm.

The nanocrystal size can be evaluated by transmission electron microscopy or X-ray diffraction analysis. It should be noted that, for the purposes of characterizing the largest dimension of the nanocrystals, preference is usually given to the direction of crystal growth, notably along the (001) direction of the crystal.

In particular, the nanocrystals may have a hexagonal prism morphology.

### Nanocrystal Synthesis

The nanocrystals may be synthesized via synthetic methods known to those skilled in the art.

Advantageously, the nanocrystals are obtained using a “bottom-up” synthetic method. Bottom-up” synthetic methods are chemical synthetic methods based on the assembly of small-sized chemical species (atoms or molecules) to produce larger-sized objects, in this case nanocrystals. This type of synthesis is thus distinct from methods for producing nanocrystals by powder grinding.

Advantageously, bottom-up nanocrystal synthesis allows precise control of the nanocrystal size and morphology.

More particularly, the doped tungsten bronze nanocrystals may be obtained by synthesis, in a solvent medium, from precursors, in particular from tungsten hexacarbonyl (W(CO)₆) and a precursor of the metal M.

In a particular embodiment, as illustrated in Example 1.2, nanocrystals of, for example, cesium-doped tungsten bronze are obtained by synthesis, in oleic acid, from tungsten hexacarbonyl (W(CO)₆) and alkali metal M oleate, for example cesium oleate.

Such a synthetic route is described, for example, in document [19]. More particularly, it involves mixing, in oleic acid, a powder of W(CO)₆ and the metal oleate precursor, in particular cesium oleate, followed by heating to a temperature of at least 200° C., in particular 300° C., for a period of at least 1 minute, in particular 30 minutes.

### Surface Functionalization of the Nanocrystals

As mentioned previously, the doped tungsten bronze nanocrystals are advantageously surface-functionalized to promote their individualized dispersion within the sol formulation used to form the solar-control coating according to the invention, and within said coating formed according to the invention.

According to a particular embodiment, the doped tungsten bronze nanocrystals are surface-functionalized with ligands bearing hydroxyl functions.

Without wishing to be bound by theory, the interactions between the hydroxyl functions of the ligands grafted onto the nanocrystal surface and the silanol functions of the silica-based sol-gel matrix precursors, as described in the text hereinbelow, promote the individual dispersion of each nanocrystal within the silica-based sol-gel network formed according to the invention.

Preferably, the doped tungsten bronze nanocrystals are surface-functionalized with polymer-type ligands, preferably branched polymers and more preferentially hyperbranched polymers, bearing hydroxyl functions.

The term “hyperbranched polymer” is intended to denote branched polymeric structures comprising at least two and notably at least three polymeric branches.

Hyperbranched polymers are generally derived from the polycondensation of one or more monomers ABx, A and B being reactive groups which can react together, x being an integer greater than or equal to 2, but other preparation processes may be envisaged.

Advantageously, the doped tungsten bronze nanocrystals are surface-functionalized with branched polyglycerol ligands, preferably hyperbranched polyglycerol.

The nanocrystals may be functionalized with polyglycerol by polymerizing the polyglycerol, for example by glycidol ring-opening polymerization, directly on the nanocrystal surface.

Thus, in a preferred embodiment, nanocrystals of doped tungsten bronzes, preferably surface-functionalized with ligands, for example ligands bearing hydroxyl functions, are prepared, prior to their use in a sol formulation according to the invention, by:
bottom-up synthesis of nanocrystals as described previously, in particular in a solvent medium from tungsten hexacarbonyl (W(CO)₆) and a precursor of the metal M, and more particularly by synthesis, in oleic acid, from tungsten hexacarbonyl (W(CO)₆) and alkali metal M oleate, for example cesium oleate; and preferably
functionalizing the surface of the synthesized nanocrystals with at least one ligand, in particular with at least one hydroxyl-bearing ligand, in particular chosen from hyperbranched hydroxyl-bearing polymers and more particularly hyperbranched polyglycerols as described previously.

Other nanocrystal surface functionalizations may be envisaged so as to promote individual nanocrystal dispersion during formation of the sol-gel matrix according to the invention.

By way of example, the nanocrystals may be surface-functionalized with ligands of the functional polyphosphate or organofunctional silane type, such as gamma-glycidoxypropyltrimethoxysilane (GLYMO) or (3-aminopropyl)triethoxysilane (APTES).

### Coating Based on Nanocrystals Dispersed in a Silica-Based Sol-Gel Matrix

As indicated previously, the invention is based on the dispersion of individually doped tungsten bronze nanocrystals in a silica-based sol-gel matrix.

### Dispersion of Silica-Based Sol-Gel Matrix Precursor(s)

As indicated previously, the coating is more particularly obtained from a sol formulation comprising at least:
said nanocrystals of doped tungsten bronzes, in particular as defined previously, preferably surface-functionalized with a ligand as described previously, in particular with a ligand bearing hydroxyl functions, for example hyperbranched polyglycerol, said nanocrystals being homogeneously and individually dispersed in a protic solvent medium, and
one or more precursors of said silica-based sol-gel matrix.

When this sol formulation is deposited on a surface, the precursors condense on evaporation of the solvent to form a solvent-entrapped network. These polymerization reactions lead to the formation of increasingly condensed species, resulting in colloidal particles forming gels. Drying and densification of these gels at a temperature of about a few hundred degrees, leads to a solid composite coating formed from a sol-gel matrix incorporating said nanocrystals.

The silica-based sol-gel matrix formed according to the invention may be a silica sol-gel matrix or even a mixed silica/titanium oxide or silica/zirconium oxide sol-gel matrix.

The precursors of the silica-based sol-gel matrix more particularly comprise at least organosilanes including hydrolyzable functions which give rise to a silica network or matrix.

In general, the organosilanes may be of the formula RₙSiX₍₄₋ₙ₎, in which:
n is equal to 0, 1, 2, 3;
the groups X, which may be identical or different, represent hydrolyzable groups chosen from alkoxy, acyloxy or halide groups, preferably alkoxy;
the groups R, which may be identical or different, represent non-hydrolyzable organic groups linked to silicon by a carbon atom.

In particular, the sol formulation according to the invention may comprise at least one organosilane of the abovementioned formula RₙSiX₍₄₋ₙ₎ in which n is 0 or 1, as a silica-based sol-gel matrix precursor, i.e. to form the sol-gel matrix, known as “sol-gel precursors”, that is capable of forming a three-dimensional network.

In particular, the sol formulation according to the invention may comprise at least one organosilane precursor whose groups are all hydrolyzable.

This sol-gel precursor is preferably a silicon alkoxide or alkoxysilane of the following formula:

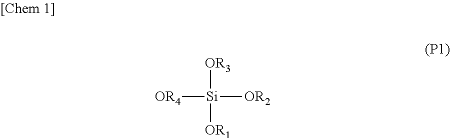

in which R₁, R₂, R₃ and R₄, which may be identical or different, preferably identical, preferably represent linear C₁-C₅ and preferably C₁-C₃ alkyl chains.

In one particular embodiment, in particular when the tungsten bronze nanocrystals are surface-functionalized with polyglycerol, the sol formulation uses, as sol-gel precursor, at least tetramethoxysilane or TMOS, of formula Si(O—CH₃)₄.

Advantageously, said alkoxysilane-type sol-gel precursor(s), whose groups are all hydrolyzable, are combined with at least one different sol-gel precursor bearing at least one non-hydrolyzable group.

Said sol-gel precursor may be more particularly of the silicon alkoxide or alkoxysilane type, comprising at least one non-hydrolyzable group, preferably of the following formula:

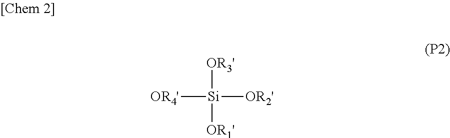

in which R₁′, R₂′, R₃′ and R₄′, which may be identical or different, preferably identical, preferably represent linear C₁-C₅ and preferably C₁-C₃ alkyl chains, and more preferentially methyl groups.

In a particular embodiment, the sol-gel precursor bearing a non-hydrolyzable group is methyltrimethoxysilane or MTMOS, of formula H₃C—Si(O—CH₃)₃.

The addition of such a sol-gel precursor, notably MTMOS, makes it possible to influence the mechanical properties of the coating formed, by relaxing the silica sol-gel network formed. In particular, it avoids fracturing of the coating film formed after cooling to room temperature.

According to a particular embodiment, the dispersion for forming a coating according to the invention thus uses, as precursors of the silica-based sol-gel matrix, a mixture of at least one alkoxysilane sol-gel precursor, all the groups of which are hydrolyzable, and at least one alkoxysilane sol-gel precursor, at least one group of which is not hydrolyzable.

Advantageously, the dispersion uses at least a mixture of TMOS and MTMOS.

Preferably, the sol-gel precursor comprising a non-hydrolyzable functional group, for example MTMOS, is present in the dispersion in a molar proportion less than or equal to that of the sol-gel precursor whose groups are all hydrolyzable, for example TMOS.

Advantageously, the mole ratio between said alkoxysilane sol-gel precursor(s), all the groups of which are hydrolyzable, and said alkoxysilane sol-gel precursor(s), at least one group of which is not hydrolyzable, in particular the mole ratio TMOS:MTOS, is strictly greater than 1, in particular between 6:4 and 9:1, preferably 7.5:3.5.

In particular, said organosilane-type precursor(s), in particular alkoxysilane, are present in the sol formulation according to the invention in a content of between 0.12 mol/L and 9 mol/L, in particular between 1 mol/L and 5 mol/L, in the sol formulation.

Needless to say, the invention is not limited to the sol-gel precursors described previously, and other precursors may be considered provided that they lead to the formation of a silica-based sol-gel matrix.

In particular, in the case of the formation of a mixed silica/titanium oxide or silica/zirconium oxide sol-gel matrix, the sol formulation according to the invention may comprise a mixture of one or more organosilane sol-gel precursors, in particular alkoxysilane, as described previously, and one or more titanium or zirconium alkoxides. Preferably, the molar amount of said precursor(s) of the titanium alkoxide (or, respectively, zirconium alkoxide) type may be between 0 and 100% of the silane amount, in particular between 0 and 30%.

Also, the sol formulation according to the invention may include one or more sol-gel precursors comprising at least one non-hydrolyzable functional group that is capable of affording the formed sol-gel matrix specific properties, for example a color, hydrophobicity, oleophobicity, anti-fouling, anti-icing, etc. properties. In particular, the sol formulation according invention to the may use gamma-glycidoxypropyltrimethoxysilane (GLYMO) as a sol-gel precursor comprising at least one non-hydrolyzable functional group, to improve the resistance of the coatings formed, notably with respect to cracking problems that may occur during drying or heat treatments.

Similarly, the sol formulation, and thus the coating formed according to the invention, based on the silica-based sol-gel matrix may optionally include, in addition to said nanocrystals according to the invention, other particles, for example pigments and/or photocatalytic systems.

The protic solvent medium of the sol formulation used to form a solar-control coating according to the invention may be formed from a single protic solvent or a mixture of protic solvents.

Said solvent(s) may be chosen more particularly from water, alcohols including from 1 to 5 carbon atoms, such as methanol, ethanol or propan-1-ol, and mixtures thereof.

According to a particular embodiment, the sol formulation according to the invention includes a mixture of water and one or more C₁-C₅ alcohols. Preferably, the protic solvent medium is a mixture of water and methanol.

The protic solvent medium advantageously represents from 40% to 99% by volume of the sol formulation according to the invention, in particular from 60% to 99% by volume.

The nanocrystals may be used in a proportion of from 1 to 50 mg/mL in the sol formulation, in particular from 1 to 15 mg/mL.

The sol formulation according to the invention may be formed by mixing the various ingredients at room temperature. Advantageously, the mixture is subjected to stirring, for example ultrasonic stirring, to enable correct homogenization and dispersion.

Preferably, the sol formulation is sonicated for between 10 and 90 minutes, for example 30 minutes, prior to application.

### Coating Formation

According to another of its aspects, the invention relates to the use of a sol formulation as defined previously to form a coating on the surface of a support.

In the context of the present invention, the term “support” refers to a solid base structure, on at least one side of which a coating according to the invention is formed.

The support may be of various types, according to the desired application.

It may be a flexible or rigid support. It may vary in shape and geometry, depending on the application for which the coating is intended. The support may or may not be flat.

Preferably, the support has good transparency properties. It advantageously has a transmittance, over the entire visible spectrum, of greater than or equal to 70%, in particular greater than or equal to 80%, notably greater than or equal to 90% and more particularly greater than or equal to 95%.

The transmittance represents the light intensity passing through said support in the visible spectrum. It may be measured, for example, by UV-Vis spectrometry, for example using a Shimadzu UV-3100 spectrometer.

The support may thus be made of glass or transparent polymers such as polycarbonate, polyolefins, polyether sulfone, polysulfone, phenolic resins, epoxy resins, polyester resins, polyimide resins, polyetherester resins, polyetheramide resins, polyvinyl acetate, cellulose nitrate, cellulose acetate, polystyrene, polyurethanes, polyacrylonitrile, polytetrafluoroethylene (PTFE), polyacrylates such as polymethyl methacrylate (PMMA), polyarylate, polyetherimides, polyether ketones, polyether ether ketones, polyvinylidene fluoride, polyesters such as polyethylene terephthalate (PET) or polyethylene naphthalate (PEN), polyamides, zirconia, or derivatives thereof.

In a particular embodiment, the support is made of glass. The coating based on the silica-based sol-gel matrix according to the invention advantageously has a good affinity with the glass support.

The support may notably have a thickness of between 500 nm and 1 cm, in particular between 10 μm and 5 mm.

By way of example, the support may be in the form of a pane of glass to which solar control properties are to be imparted, in particular for which good transparency in the visible range is to be maintained, while screening out UV and near-infrared radiation.

The invention also relates to a support, preferably a transparent support, having on at least one of its sides a coating formed from a sol formulation according to the invention.

The process for preparing a coating according to the invention is, of course, adapted to the configuration of the support to be coated.

In general, as mentioned previously, formation of the coating involves the steps of (ii) depositing a layer of said dispersion on the surface of the support and (iii) drying the layer to form the coating based on said silica-based sol-gel matrix.

The sol formulation may be applied to the surface of the substrate to be coated via any liquid-phase deposition technique known to those skilled in the art. For example, the deposition in step (ii) of said sol formulation is performed by spin-coating, by slot-die coating, by blade-coating, by spraying, by dip-coating, etc.

In a particular embodiment, the sol formulation is applied by spin-coating.

The deposited dispersion layer may have a thickness of between 20 nm and 10 μm, in particular between 100 nm and 5 μm.

The deposited layer advantageously has a uniform thickness.

Thus, the deposited layer is preferably homogeneous in composition and thickness.

The sol-gel coating is obtained by hardening the dispersion and thus comprises the product resulting from the hydrolysis and condensation of said precursor(s) of said silica-based sol-gel matrix, in particular of said organosilane(s) as described previously, optionally as a mixture with one or more titanium or zirconium alkoxides.

Drying is performed under conditions conducive to condensation of the sol-gel precursors and to removal of said solvent(s), to form the silica-based sol-gel network.

In particular, it may be performed at a temperature of between 40° C. and 250° C., in particular about 100° C., notably for a period of between 1 hour and 48 hours, in particular between 3 hours and 24 hours.

The film or coating obtained is thus based on the silica-based sol-gel matrix formed from the sol-gel precursors, in particular as defined previously, in which the doped tungsten bronze nanocrystals are dispersed in an individualized and homogeneous manner.

The coating may have a thickness of between 10 nm and 25 μm, in particular between 30 nm and 10 μm, and more particularly between 100 nm and 7 μm.

The nanocrystals may be present in the composite coating formed in a volumetric fraction ranging from 0.1% to 30% by volume, in particular from 0.5% to 15% by volume.

Preferably, the nanocrystal volumetric fraction in the composite coating is less than or equal to 5%, in particular not exceeding 3%, for example between 0.5% and 2.7%.

Advantageously, the distance between nanocrystals within the coating formed according to the invention is strictly greater than the largest dimension of the nanocrystals. In particular, the distance between the nanocrystals may be strictly greater than 4 nm and less than or equal to 100 nm, in particular between 10 nm and 50 nm. This distance may be evaluated by analyzing images obtained by 3D tomographic transmission electron microscopy, as illustrated in the following examples.

It is understood that a structure according to the invention comprising at least one support bearing on at least one of its faces said solar-control coating according to the invention may also comprise one or more additional layers, for example an anti-scratch, anti-reflective layer, a multilayer stack of Bragg mirror type, etc., notably according to the intended application.

In particular, a structure according to the invention may also comprise a protective layer on the surface of the solar-control coating. The solar-control coating may notably be interposed between the support and the protective layer.

In particular, the protective layer may be made of amorphous silicon; SiₜNₓO_{y}C_{z}Hᵤ with t between 0 and 1, x between 0 and 4/3, y between 0 and 2, z between 0 and 1 and u between 0 and 4, notably SiₜNₓ with t between 0 and 1 and x between 0 and 4/3, or SiO₂, preferably Si₃N₄ or SiO₂; Al₂O₃; ZrO₂; ZnO; Ag; Al; of a polymer, notably chosen from polyvinyl alcohol (PVA), polyvinylpyrrolidone (PVP), polymethyl methacrylate (PMMA) and poly(butyl acrylate) (PBA); or mixtures thereof. Preferably, the protective layer may be made of Si₃N₄, SiO₂, Al₂O₃ or mixtures thereof. The protective layer may also be made of a polymer chosen from PVA, PVP, PMMA and PBA. Advantageously, the protective layer may be made of a material having high transparency. For example, it may be deposited by evaporation, chemical vapor deposition (CVD), cathodic sputtering or liquid deposition.

As mentioned previously, a solar-control coating according to the invention may be fitted to a variety of objects, for a wide range of applications.

The structure according to the invention may be used more particularly for a glazing, for example a window, for example in buildings, verandas, windshields of motor vehicles, glazing of trains for example, portholes, or else to equip greenhouses used in agriculture or the surface of photovoltaic panels.

Needless to say, the use of a solar-control coating according to the invention is not limited to the applications described above, and other applications of a sol formulation and/or coating according to the invention may be envisioned.

The invention will now be described by means of the following examples and figures, which are of course given as nonlimiting illustrations of the invention.

### EXAMPLE

In the examples that follow, the characterizations were performed as follows.

### X-Ray Analysis (XRD)

X-ray diffraction (XRD) patterns were obtained using a Bruker D8 Advance diffractometer with a Cu Kα X-ray operating at 40 kV and 40 mA. Data are collected between 2θ=5° and 2θ=90° with a step size of 0.02° and a scan speed of 0.9 sec/step. For analysis, the nanocrystals were deposited via a drop-casting technique on an oriented silicon wafer substrate (400).

### Fourier Transform Infrared Spectroscopy (FTIR)

Fourier transform infrared (FTIR) spectroscopy measurements were performed using nanocrystal pellets (2% by mass) in KBr on a Brüker Equinox 55 spectrometer in transmission mode.

### Dynamic Light Scattering (DLS)

Measurements were performed on a Zeta-Sizer Nano ZS machine, with a total of three measurements per sample.

### Scanning Electron Microscopy (SEM)

A Hitachi 4800 SEM scanning electron microscope (SEM) was used to image the films on a silicon wafer (surface and cross-section).

### Film Extinction Spectra

The extinction spectra of the films were measured using a LabSpec 4 ASD spectrophotometer connected to the glovebox with fiber optics.

### Reflectivity Measurements

Reflectivity measurements were performed on a UMA machine of an Agilent-Cary5000 spectrophotometer, with an angle of incidence of 5° and a detector positioned at 10°.

### Image Processing

The reconstructions obtained were processed using ImageJ software. Firstly, a 3D hybrid media filter was applied to reduce noise, followed by binarization of the volume with a common threshold calculated using a maximum entropy method. A further 3D media filtering step was used on the binary volume with a structuring object size of 2×2×2 nm³. The volume was binarized with a threshold calculated from the image using an Otsu method and segmentation/labeling was done using the “3D object counter” plugin, which also allows extraction of nanocrystal centroid coordinates and volume. The Voronoi algorithm was calculated using the centroid position with the “Tess library on Pithon”. It creates 3D polyhedra (called Voronoi cells), each containing a particle. The faces of these polyhedra are defined as the assembly of points at tangential distances between two neighboring particles.

### Example 1

1.1 Synthesis of Nanocrystals with Different Aspect Ratios

The Schlenk line technique was used to synthesize these nanocrystals. Oleic acid (technical grade, 90%, from Sigma-Aldrich) was used as solvent and degassed for 3 hours at 120° C. prior to synthesis.

To obtain aspect ratios of 0.5 and 0.8, 652 mg (2 mmol) of WCl₄ were mixed with 10 mL of oleic acid (0.2 M) and degassed for 30 min at 120° C. to prepare the tungsten oleate precursor. In separate bottles, 56 mg (0.33 mmol) and 1060 mg (6 mmol) of CsCl (Sigma-Aldrich) were mixed with 45 mL of oleic acid for aspect ratios of 0.5 and 0.8, respectively. The mixture was degassed for 30 minutes at 120° C., then heated to 300° C. under a nitrogen atmosphere, and 5 mL (1 mmol) of the tungsten oleate precursor were then rapidly injected.

To obtain aspect ratios of 1.8 and 2.9, the cesium oleate precursor was prepared by degassing a 0.2 M solution of Cs₂CO₃ (Sigma-Aldrich) in oleic acid for 30 min at 120° C. Next, 156 mg (0.44 mmol) of W(CO)₆ (Sigma-Aldrich) were mixed with 73 μL (0.015 mmol) and 36.5 μL (0.007 mmol) of the cesium oleate precursor and 20 mL of oleic acid for aspect ratios of 1.8 and 2.9, respectively. The mixture was degassed for 30 minutes, and then heated to 300° C.

To obtain an aspect ratio of 6.2, the tungsten oleate precursor was prepared by leaving 10 mL of 0.1 M W(CO)₆ solution in oleic acid at 180° C. in an oil bath under a nitrogen stream overnight. 1 mL of this solution was injected into a 0.75 mM cesium oleate precursor solution in oleic acid at 300° C.

For all the aspect ratios, the reaction mixtures were maintained at 300° C. for 30 minutes and then cooled to room temperature. The reaction flask was transferred to a glovebox under a nitrogen atmosphere, the nanocrystals were washed by centrifugation, and then dispersed in toluene at a concentration of 10 mg/mL.

The nanocrystals obtained are analyzed by transmission electron microscopy (TEM) and their dimensions, measured on more than 200 particles, are reported in Table 1 below.

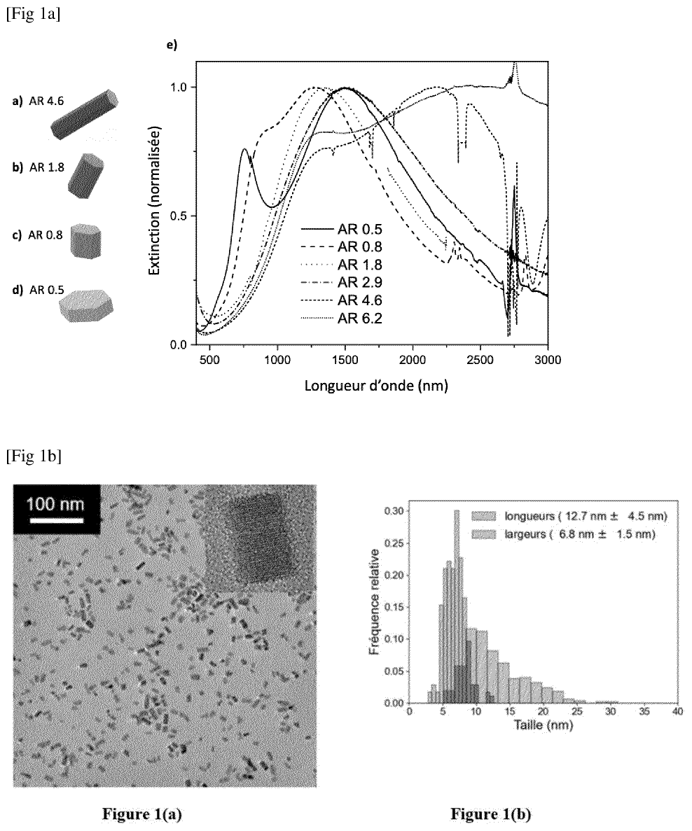

Their morphology is also represented in FIG. 1a.

TABLE 1

| AR | 0.5 | 0.8 | 1.8 | 2.9 | 6.2 |
|---|---|---|---|---|---|
| Length | 4.7 ± 1.4 | 10.4 ± 4.1 | 12.9 ± 4.7 | 54.3 ± 13.4 | 31.8 ± 11.0 |
| (nm) | | | | | |
| Width | 9.9 ± 2.6 | 13.4 ± 4.0 | 7.4 ± 2.3 | 18.5 ± 3.2 | 5.3 ± 1.6 |
| (nm) | | | | | |

The extinction spectra of the various nanocrystals are measured in solution in TCE (tetrachloroethylene) and shown in FIG. 1a. It is observed that the aspect ratio of the nanocrystals allows adjustment of the position and spectral shape of the localized surface plasmon resonance (LSPR) peak.

1.2 Synthesis of CsₓWO_{3-y} nanocrystals (Also noted as “h-Cs:WO₃”) (Hexagonal Structure)

Nanocrystals of the CsₓWO_{3-y} type, of the nanorod type, with a hexagonal crystallographic structure, noted h-Cs:WO₃, having an aspect ratio (AR) of 1.9 (width of 6.8±1.5 nm and length of 12.7±4.5 nm) were synthesized according to the following protocol, using a heating process for W(CO)₆ powder and a cesium oleate precursor obtained from cesium carbonate (Cs₂CO₃) in oleic acid.

The Schlenk line technique (vacuum gas collector) was used to synthesize these nanocrystals.

Oleic acid (technical grade, 90%, from Sigma-Aldrich) was used as solvent and degassed for 3 h at 120° C. prior to synthesis. 236 mg (1 mmol) of Cs₂CO₃ were mixed with 10 mL of oleic acid (0.2 M cesium) and degassed for 30 minutes at 120° C. under vacuum to prepare the cesium oleate precursor.

Next, 156 mg (0.44 mmol) of W(CO)₆ were mixed with 326 μL (0.06 mmol) of cesium oleate and 39.67 mL of oleic acid. The mixture was degassed for 30 minutes under vacuum, then heated to 300° C. under a nitrogen atmosphere, maintained for 30 minutes and cooled to room temperature.

The reaction flask was transferred to a glovebox, washed with 2-propanol, and the nanocrystals were dispersed in toluene.

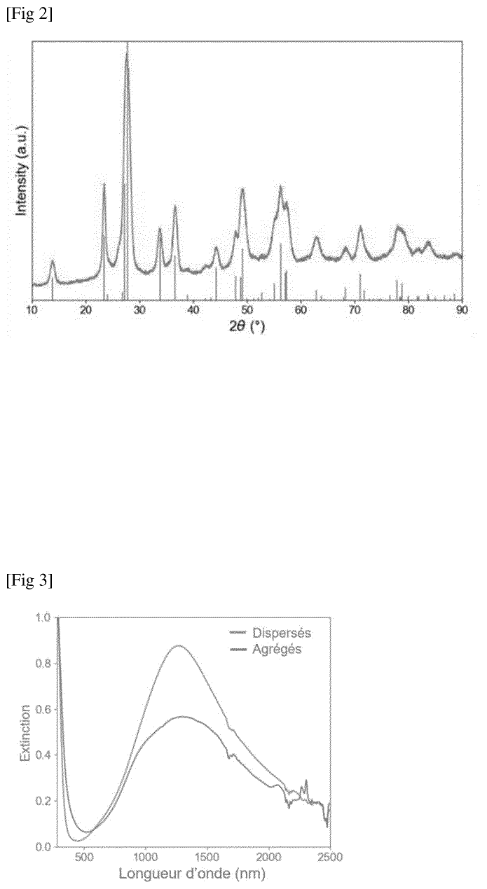

FIG. 1b is a transmission electron microscopy (TEM) photograph of the nanocrystals obtained. Analysis by high-resolution transmission electron microscopy (HRTEM) confirms that the nanocrystals obtained are indeed monocrystalline, while images by X-ray analysis (XRD) (FIG. 2) confirm the hexagonal phase of the tungsten bronze.

### Example 2 (Comparative)

Preparation of a Film Based on Nanocrystals Surface-Functionalized with DMOAP Ligands
2.1. Preparation of Nanocrystals Surface-Functionalized with DMOAP Ligands (Referred to as NC@DMOAP)

After the synthesis described in Example 1.2, visually examined nanocrystals stored in toluene tend to aggregate and flocculate over time. To prevent this phenomenon, the oleic acid ligands surrounding the nanocrystals are exchanged for DMOAP (N,N-dimethyl-N-[3-(trimethoxysilyl) propyl]-1-octadecanaminium chloride) ligands, according to the following protocol.

10 mg of nanocrystals (2.5 mg/mL in toluene) are mixed with 100 μL of DMOAP (42% in methanol) and sonicated for one hour, then washed with ethanol.

Exchanging the oleic acid ligands with DMOAP-type ligands enhances their colloidal stability in a nonpolar solvent, such as toluene or tetrachloroethylene.

FIG. 3 shows the extinction spectrum of nanocrystals coated with oleic acid (in an aggregated state) and with DMOAP (dispersed state) at the same concentration (0.0667 mg/mL): aggregated particles have a higher extinction coefficient in the visible range due to aggregate diffusion, while their LSPR is less intense due to the coupling effect between nanocrystals [11].

This test shows that the dispersion state of plasmonic nanocrystals has a major impact on their optical properties.

### 2.2. Preparation of a Film Based on NC@DMOAP Nanocrystals

A film based on NC@DMOAP nanocrystals was prepared by spin-coating a 60 mg/mL solution of NC@DMOAP nanocrystals in toluene at 1000 rpm-90 sec. A compact, homogeneous NC@DMOAP film was obtained.

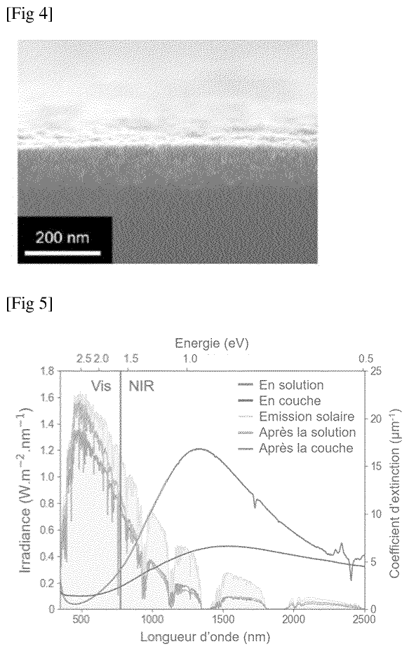

FIG. 4 represents the scanning electron microscopy (SEM) image of the cross-section of the film obtained.

FIG. 5 shows the spectrum of the extinction coefficient & of the nanocrystals dispersed in solution and in the film, calculated according to Beer-Lambert's Law:

$$A = ε . I . fV \qquad [ Math . 1 ]$$

with A representing the absorption at a specific wavelength (absorption maximum);
I the optical path length through the sample (corresponding to the film thickness); and
f_{V} the nanocrystal volumetric fraction (set at 70% for the film [12], [20]).

This representation is normalized by the total volume of nanocrystals and by the sample geometry, allowing easier comparison between different configurations.

It may be observed that the feature in terms of LSPR for the film is degraded compared to the solution, as expected due to the LSPR coupling effect when nanocrystals are stacked; the transparency in the visible range is also degraded.

The selectivity toward near-infrared radiation (NIR) for solar protection applications can be evaluated by convolving their spectra with solar radiation (FIG. 5), and by calculating their solar energy transmittance selectivity (SETS) [18], and also their NIR absorption percentage (A_{NIR}) for a visible transmittance set at 80%. The SETS and A_{NIR} values, calculated in accordance with the S.I., are collated in Table 2 below.

TABLE 2

| | | | ε |
|---|---|---|---|
| Sample | A_{NIR} | SETS | (μm⁻¹) |
| Ground Cs_{0.33}WO₃ [18] | 72.6% | 0.713 | 8.5 [16] |
| CsₓWO_{3-y} nanocrystals with an aspect ratio of | 75.6% | 0.778 | 17.5 |
| 1.9 as a solution | | | |
| CsₓWO_{3-y} nanocrystals with an aspect ratio of | 48.6% | 0.643 | 7.3 |
| 1.9 as a dense film | | | |

The transition from nanocrystals dispersed in solution to compact films leads to a 36% loss of A_{NIR} and a 58% loss of extinction coefficient.

Also, the values obtained for solar energy transmission selectivity and NIR absorption percentage, SETS=0.778 and A_{NIR}=75.6%, for a well-dispersed solution attest to better selectivity obtained with CsₓWO_{3-y} nanocrystals with a precise morphology (aspect ratio of 1.9), compared with Cs_{0.33} WO₃ powders (SETS=0.713 and A_{NIR}=72.6%) [18]. These results highlight the advantage of precisely controlling particle size and shape, and thus the position of their LSPR, using bottom-up synthesis.

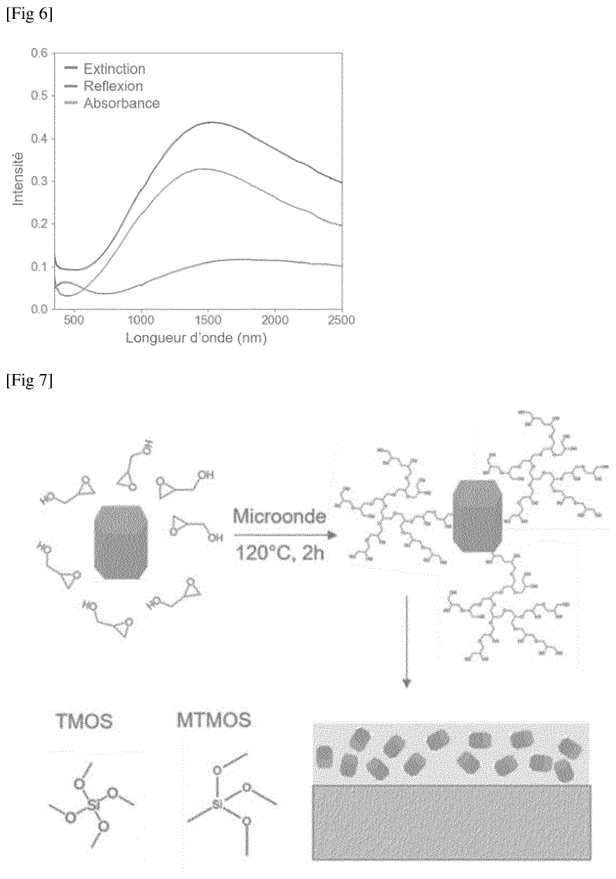

The loss of transparency in the visible range is due to the refractive index of the nanocrystals, which makes the film reflective (FIG. 6). The film is also reflective in the NIR, representing 25% of the total extinction in this wavelength range.

The effect on the absorption of stacking the nanocrystals as a dense layer can be estimated by subtracting the reflectivity from the extinction.

It is seen that LSPR coupling between nanocrystals in the dense film formed is responsible for a 72% reduction in NIR absorption.

### Example 3

Preparation of a Composite Film According to the Invention Based on Nanocrystals Surface-Functionalized with Polyglycerol
3.1. Preparation of Nanocrystals Surface-Functionalized with Hyperbranched Polyglycerol (Noted “Hyperbranched NC@Polyglycerol”)

The nanocrystals synthesized in oleic acid as described in Example 1.2 were surface-functionalized with polyglycerol ligands, following the protocol described below, adapted from the literature [22], [23].

1 mL of a solution of nanocrystals in toluene, as synthesized in Example 1.2, was added to 1.25 mL of glycidol in a Teflon-sealed glass tube. The tube was placed in a microwave oven; the temperature was raised to 120° C. and maintained for 2 hours. After reaction, the mixture was cooled to room temperature, washed with acetone and by repeated ultrafiltration (10 000 daltons), in methanol to remove free polymers.

Microwave heating enables the ring-opening polymerization of the glycidol on the surface of nanocrystals to be initiated; the hyperbranched polyglycerol polymers obtained bear numerous hydroxyl groups (FIG. 7), ensuring good solubility in water and methanol by establishing hydrogen bonding.

### Results

The nanocrystals surface-functionalized with polyglycerol have the same shape and dimensions (7.2±1.7 nm×13.7±4.9 nm) before and after functionalization, demonstrating that the reaction does not attack the nanocrystal surface and that the ligand shell surrounds an individual nanocrystal.

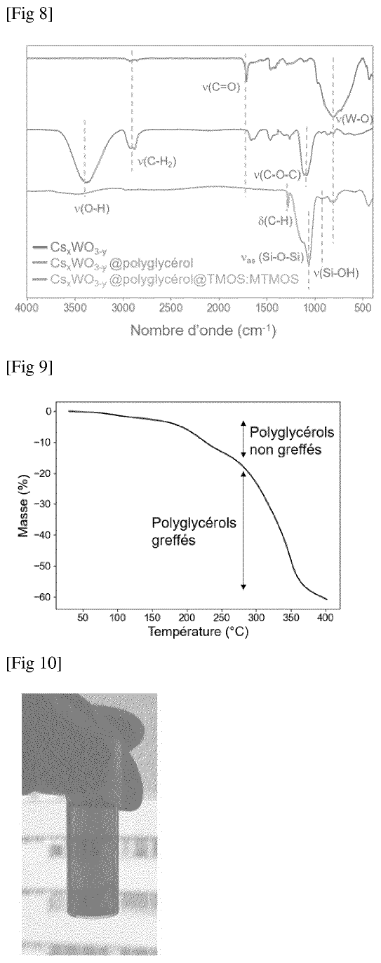

Fourier transform infrared (FTIR) spectroscopy (FIG. 8) confirms the grafting efficacy of the polyglycerol ligands: the absorption band at 1700 cm⁻¹ (C═O valence vibration) attributable to oleic acid is no longer visible after grafting. On the other hand, the absorption bands at 1096 cm⁻¹ (C—O—C valence vibration), 2900 cm⁻¹ (C—H₂ valence vibration) and 3380 cm⁻¹ (—OH valence vibration of hydrogen bonds), are the signature of polyglycerol.

Absorption bands in the 500-1030 cm⁻¹ region correspond to the W—O units of h-CsWO₃ particles.

Thermogravimetric analysis (FIG. 9) indicates that the glycerol shell represents 56% of the total mass of the sample. The density of ligands connected to the surface of the nanocrystals can be estimated at about 40 monomers/nm², which corresponds to a lower density of polyglycerol molecular chains, variable as a function of polymer chain length.

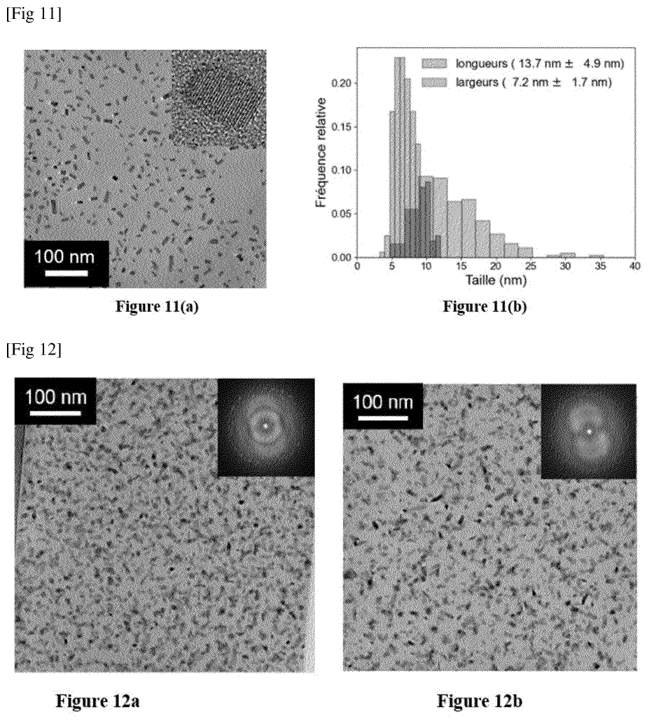

Correct dispersion of the functionalized nanocrystals in methanol was verified by the visual appearance of the solution, which does not scatter light (FIG. 10), and by TEM imaging showing well-dispersed nanocrystals on the grid (FIG. 11).

Moreover, dynamic light scattering (DLS) measurements confirm a monodisperse particle distribution with a hydrodynamic radius of 20.8±0.7 nm, which is in accordance with the dimensions of the nanorods and the radius obtained for DMOAP-functionalized nanocrystals (NC@DMOAP) in toluene (18.1±3.1 nm).

### 3.2 Formation of the Composite Film According to the Invention of Functionalized Nanocrystals in a Sol-Gel Matrix

A mixture of tetramethoxysilane (TMOS) and methyltrimethoxysilane (MTMOS) is chosen as precursors for the formation of the sol-gel composite. Hydrolysis of TMOS and MTMOS produces methanol.

The silica sol-gel matrix incorporating hyperbranched NC@polyglycerol nanocrystals is formed as follows.

0.75 molar equivalent of TMOS was mixed with 0.35 molar equivalent of MTMOS and 4 molar equivalents of H₂O at pH 1. The solution was stirred for one hour, diluted to the desired concentration in methanol and then added to the hyperbranched NC@polyglycerol nanocrystals.

For all the samples, the nanocrystal concentration was set at 9 mg/mL and the amount of silica was increased. The solutions were sonicated for 30 minutes to initiate condensation, and deposition was then performed by spin-coating at 1000 rpm⁻⁹⁰ sec. The films were then placed on a hot plate at 100° C. overnight.

Each film was formed, on the one hand, on a silicon wafer for electron microscopy analysis and, on the other, on glass for optical measurements.

Without wishing to be bound by theory, the individual dispersion of each nanocrystal in the network is favored due to the strong interactions between the numerous-OH groups of the ligands grafted onto the nanocrystal surface and the silanol functions of the silica precursors.

The addition of MTMOS allows the mechanical properties of the layer to be improved by relaxing the silica network. The TMOS:MTMOS mole ratio advantageously enabling fracturing of the layer to be avoided after cooling to room temperature is 7.5:3.5.

The FTIR spectrum of the composite film (FIG. 8) shows a strong absorption band at 1063 cm⁻¹ (asymmetric Si—O—Si valence vibration) combined with weak bands at 960 cm⁻¹ (Si—OH valence vibration) and 3470 cm⁻¹ (—OH valence vibration), confirming the high degree of condensation [24].

### Example 4

### Characterization of the Silica Sol-Gel Matrix Film Incorporating Hyperbranched NC@Polyglycerol Nanocrystals

Several composite coatings with different volumetric fractions of nanocrystals (f_{V} from 0.9% to 14.6%) in the silica matrix were prepared, as described in Example 3, to study the impact of their structure on their optical properties.

The precise structures were studied by electron tomography. Films with nanocrystal volumetric fractions f_{V}=1.1% and f_{V}=2.7% were reduced to 200 nm thickness by FIB (Focused Ion Beam).

2D projections by TEM analysis at an angle of 0° (FIG. 12) still shows good nanocrystal dispersion in all cases.

The fast Fourier transform method highlights the existence of an edge contrast which corresponds to the families of crystal planes of the P63/mcm space group with a hexagonal crystal lattice, associated with the h-CsₓWO_{3-y} nanocrystal.

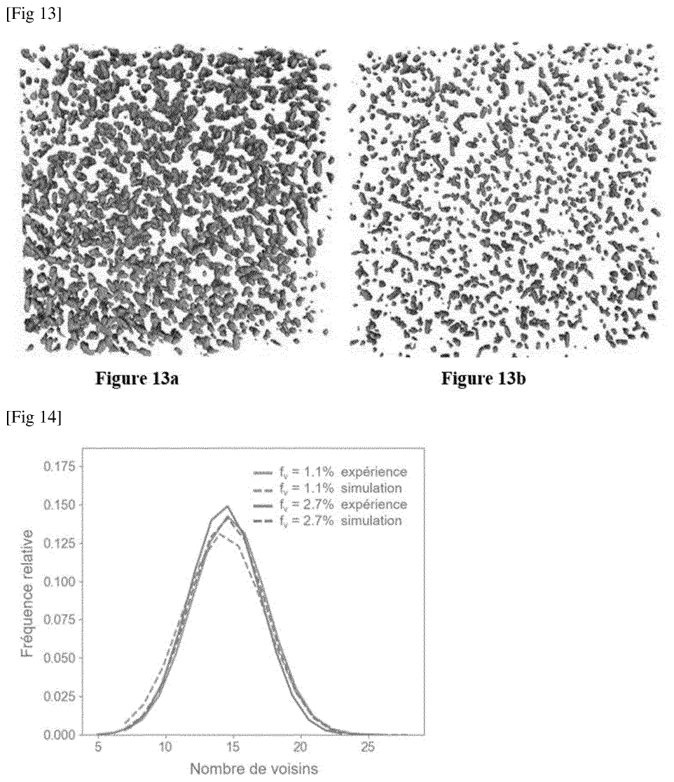

FIG. 13 shows the segmented 3D model for each volumetric fraction extracted from the tomography data. The elongation of nanocrystals in the z-direction, caused by the “missing apex” in the acquisition of the tilt series [25], can be observed: it induces a loss of resolution in the direction parallel to the beam direction, thus deforming the nanocrystal. Their volumetric distribution was extracted from the analyzed volume and compared with their distribution by standard TEM of nanocrystals deposited via a technique of droplet deposition on carbon grids. The 33% difference obtained may be attributed to this deformation, confirming the reliability of the present image processing and highlighting the individual dispersion of the nanocrystals.

The homogeneity of the nanocrystal dispersion was analyzed using the Voronoi cell algorithm and compared to the random arrangement of particles with the same particle density. This calculation is often used to characterize granular dispersions, as it allows the local environment of each particle to be described. Nanocrystals were defined by the positions of their centers of gravity rather than by their surface area, to overcome the artifact of elongation in the z-direction.

Three parameters were extracted from the Voronoi tessellation, summarized in Table 3 below.

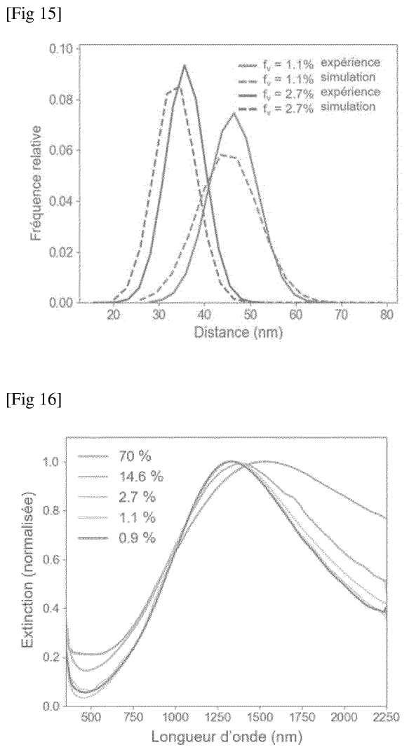

The number of nearest neighbors of each nanocrystal, denoted N_{neighbors} (corresponding to the cell face numbers in Voronoi's tessellation) shows a monodisperse distribution in all cases (FIG. 14), meaning that each nanocrystal has the same local environment. Furthermore, the distributions are centered around 14-15 neighbors, which corresponds to a random stacking of individual spheres in the literature. Moreover, histograms of the local volumetric fraction f_{V,local} (defined as the average volume of the nanocrystals divided by the cell volume) are also monodisperse, with a mean value corresponding to the macroscopic volumetric fraction and a standard deviation corresponding to that of the nanocrystal size. These two elements and the good agreement between experiments and simulations suggest a homogeneous dispersion for both samples. Furthermore, the histograms of distance between nearest neighbors, noted d_{N-N}, have the same shape between experiment and simulation (FIG. 15). The slight difference in mean value may be attributed to the electrostatic repulsion between nanocrystals in the experiment.

TABLE 3

| Sample | N_{neighbors} | d_{N-N} (nm) | f_{V, local} (%) |
|---|---|---|---|
| Experiment for f_{V} of 1.1% | 14.7 ± 2.8 | 24.6 ± 5.7 | 1.1 ± 0.4 |
| Simulation for f_{V} of 1.1% | 15.4 ± 3.2 | 20.9 ± 6.3 | 1.3 ± 0.6 |
| Experiment for f_{V} of 2.7% | 14.4 ± 2.7 | 20.0 ± 4.6 | 2.2 ± 0.9 |
| Simulation for f_{V} of 2.7% | 15.4 ± 3.1 | 16.2 ± 4.0 | 3.2 ± 1.3 |

Parameters extracted from Voronoi tessellation for samples with nanocrystal volumetric fractions of 1.1% and 2.7% for experiments and simulations.

In conclusion, the coatings formed according to the invention do indeed have an individual and homogeneous dispersion of nanocrystals in TMOS:MTMOS sol-gel matrices at least up to a nanocrystal volumetric fraction of f_{V}=2.7% (corresponding to 200 mg/mL).

The main difference relating to the structure of the different films for f_{V}≤2.7% is thus the distance between the nanocrystals.

### Example 5

### Effect of Film Nanocrystal Volumetric Fraction on Optical Properties

Normalized extinction spectra of composite films with different nanocrystal volumetric fractions, prepared as described in Example 3, are shown in FIG. 16. It can be seen that the transparency in the visible range increases as f_{V} decreases. This effect is attributed to the reduced reflectivity of the films as the silica content increases. Furthermore, the more diluted the nanocrystals, the narrower and more blue-shifted the NIR extinction.

The effect of film structure on nanocrystal LSPR was analyzed by examining absorption only (taken as extinction-reflectivity). The position of the peak is red-shifted as f_{V} increases, due to the combined effect of LSPR coupling and the change in the refractive index of the nanocrystal's surrounding medium.

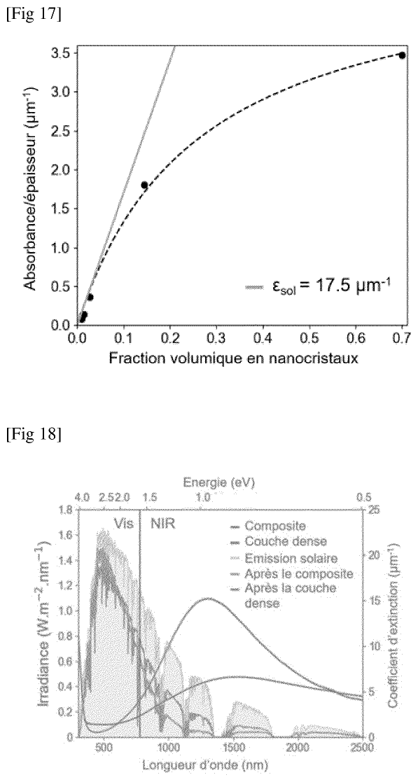

In addition to the red shift of the LSPR position, LSPR coupling also has an impact on the nanocrystal's extinction coefficient. For a nanocrystal volumetric fraction greater than 2.7%, this leads to a deviation from the linearity of the Beer-Lambert law (FIG. 17) as a degradation of the extinction coefficient. Here, the slope of the reference line is taken as the extinction coefficient of the nanocrystal in a well-dispersed solution. This deviation starts at a center-to-center distance between nanocrystals of 20.0±4.6 nm, corresponding to a surface-to-surface distance of 10.0±2.3 nm corresponding to the mean size of the nanocrystal. This corresponds to the plasmon hybridization model established for metal nanoparticles, indicating that LSPR coupling between two particles begins to occur when the surface-to-surface distance between them is approximately equal to the particle diameter.

Thus, the optimum nanocrystal content in the film for maintaining good NIR selectivity and a good extinction coefficient is f_{V}<2.7%. The reason for this is that the coating with f_{V}=1.1% has optical parameters of NIR absorbance A_{NIR}=74.2%, solar energy transmittance selectivity SETS=0.770 and extinction coefficient ε=15.3 μm⁻¹ (FIG. 18).

These results are very close to the parameters in a well-dispersed solution, and higher than those obtained for milled powders dispersed in silica (SETS=0.757 and A_{NIR}=71.4%) [18]. Furthermore, A_{NIR} is calculated for a visible transmission of 80%, which is achieved here with a coating thickness of 6.0 μm corresponding to two layers spin-coated one on top of the other.

### Example 6

### Effect of a Protective Layer on the Stability of the Extinction Spectrum

Nanocrystals with an aspect ratio of 0.5 were synthesized as described in Example 1.1.

The nanocrystals were surface-functionalized with hyperbranched polyglycerol according to a protocol similar to that detailed in Example 3, and dispersed in methanol.

Gamma-glycidoxypropyltrimethoxysilane (GLYMO) is chosen as the precursor for forming the sol-gel composite. The composite incorporating functionalized nanocrystals with an aspect ratio of 0.5 is formed as follows:

0.97 mL of water at pH=1.0 (HCl) is added dropwise to 4 mL of GLYMO and the mixture is left under stirring for hydrolysis for 2 h. 0.172 g of aluminum acetylacetonate (Al(acac)₃) is then added and the solution is stirred until dissolution is complete. The solution of polyglycerol-functionalized nanocrystals dispersed in methanol at a concentration of 10 mg/mL is added in an amount affording a final nanocrystal volumetric fraction in the matrix of about f_{V}=1.1%. After sonication for 30 min, the solution is spin-coated at 1000 rpm for 90 s onto a glass substrate previously cleaned by pyranha treatment. The layers obtained are dried at 100° C. for 3 h to form the solar-control coating.

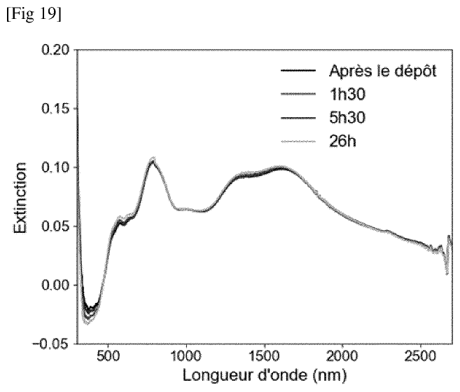

A 50 nm-thick amorphous silicon protective layer is then deposited on the solar-control coating by plasma-enhanced chemical vapor deposition (PECVD). The structure obtained is then left in ambient air, and extinction spectra of the coating are measured over time. These are shown in FIG. 19, after subtracting the contribution of amorphous silicon. No decrease in absorption was observed over a period of 26 h, demonstrating that the protective layer is effective in preventing nanocrystal oxidation, notably when exposed to air.

### LIST OF CITED DOCUMENTS

[1] Schaefer et al., Surf. Coatings Technol. 93, 37-45 (1997);
[2] Martin-Palma et al., Sol. Energy Mater. Sol. Cells 55-66 (1998) doi:10.1002/col.22225;
[3] Boisselier et al., Chem. Soc. Rev. 38, 1759-1782 (2009);
[4] Takahata et al., J. Am. Chem. Soc. 136, 8489-8491 (2014);
[5] Nütz et al., J. Chem. Phys. 110, 12142-12150 (1999);
[6] Luther et al., Nat. Mater. 10, 361-366 (2011);
[7] Kanehara et al., J. Am. Chem. Soc. 131, 17736-17737 (2009);
[8] Dorfs, D. et al., J. Am. Chem. Soc. 133, 11175-11180 (2011);
[9] Lounis et al., J. Phys. Chem. Lett. 5, 1564-1574 (2014);
[10] Ohodnicki, P. R. et al., Thin Solid Films 539, 327-336 (2013);
[11] Guo, W. et al., Adv. Mater. 29, 1-9 (2017);
[12] Kim, J. et al., Nano Lett. 15, 5574-5579 (2015);
[13] Llordés et al., Nature 500, 323-326 (2013);
[14] Mattox, T. M. et al., Chem. Mater. 27, 6620-6624 (2015);
   [15] Takeda et al., J. Am. Ceram. Soc. 90, 4059-4061 (2007);
[16] Adachi, K. & Asahi, J. Mater. Res. 27, 965-970 (2012);
[17] Mattox et al., Chem. Mater. 26, 1779-1784 (2014);
[18] Zeng, X. et al., J. Mater. Chem. C 3, 8050-8060 (2015);
[19] Kim, J., et al., Nano Lett. 16, 3879-3884 (2016);
[20] Heo, S., et al., ACS Energy Lett. 5, 2662-2670 (2020);
[21] Weisbecker, C. S., et al., Langmuir 12, 3763-3772 (1996);
[22] Zhao, L. et al., Adv. Funct. Mater. 22, 5107-5117 (2012);
[23] Yu, B. et al., Colloids Surfaces A Physicochem. Eng. Asp. 596, 124734 (2020);
[24] Capozzi, C. A. et al., Spectrosc. Lett. 26, 1335-1348 (1993);
[25] Midgley, P. A. & Weyland, M. Ultramicroscopy 96, 413-431 (2003);
[26] Dalmas, F. et al., 3D Dispersion of Spherical Silica Nanoparticles in Polymer Nanocomposites: A Quantitative Study by Electron Tomography (2014);
[27] Yang, R. Y., et al., Phys. Rev. E-Stat. Physics, Plasmas, Fluids, Relat. Interdiscip. Top. 65, 8 (2002);
[28] Su, K. H. et al., Nano Lett. 3, 1087-1090 (2003).
[29] Hussain, A., et al., Journal of Alloys and Compounds, 246 (1-2), 51-61 (1997).

1. A sol formulation, which is useful for forming a solar-control coating, comprising at least;
one or more silica-based sol-gel matrix precursors, and
nanocrystals of the type MₓWO_{3-y}, with M representing potassium (K), sodium (Na) or cesium (Cs), x ranging from 0.05 to 0.33 and y from 0 to 0.4, referred to as doped tungsten bronze nanocrystals, homogeneously and individually dispersed in a protic solvent medium.

2. The sol formulation as claimed in claim 1, wherein said doped tungsten bronze nanocrystals are surface-functionalized with at least one ligand that is capable of promoting good dispersion of said nanocrystals within the sol formulation.

3. The sol formulation as claimed in claim 1, wherein said nanocrystals are cesium-doped tungsten bronze nanocrystals.

4. The sol formulation as claimed claim 1, wherein said nanocrystals are previously obtained via a bottom-up synthetic route.

5. The sol formulation as claimed in claim 1, wherein said nanocrystals have a hexagonal prism morphology.

6. The sol formulation as claimed in claim 1, wherein said nanocrystals are in the form of nanorods.

7. The sol formulation as claimed in claim 1, wherein said doped tungsten bronze nanocrystals have a controlled size and morphology so as to adjust the spectral position of their localized surface plasmon resonance (LSPR) peak.

8. The sol formulation as claimed in claim 1, wherein said doped tungsten bronze nanocrystals have a degree of doping with alkali metal of between 0.05 and 0.33 and/or a free carrier density of between 1×10¹⁸ and 9×10²² cm⁻³.

9. The sol formulation as claimed in claim 1, wherein said doped tungsten bronze nanocrystals are present in an amount of from 1 to 50 mg/mL in the sol formulation.

10. The sol formulation as claimed in claim 1, wherein it comprises, as a precursor of the silica-based sol-gel matrix, at least one organosilane of formula
RₙSiX₍₄₋ₙ₎,
in which:
n is equal to 0 or 1;
the groups X, which may be identical or different, represent hydrolyzable groups chosen from alkoxy, acyloxy or halide groups;
the groups R, which may be identical or different, represent non-hydrolyzable organic groups bonded to silicon via a carbon atom.

11. The sol formulation as claimed in claim 1, wherein it comprises, as silica-based sol-gel matrix precursors, at least a mixture of tetramethoxysilane (TMOS) and methyltrimethoxysilane (MTMOS).

12. The sol formulation as claimed in claim 1, wherein the protic solvent medium is formed by one or more solvents chosen from water and alcohols including from 1 to 5 carbon atoms.

13. A method of forming a solar-control coating on the surface of a support, using a sol formulation as defined in claim 1.

14. A process for forming a solar-control coating on the surface of a support, comprising at least the steps consisting in:
(i) providing a sol formulation as defined in claim 1, comprising at least one or more silica-based sol-gel matrix precursors and doped tungsten bronze nanocrystals, said nanocrystals being homogeneously and individually dispersed in a protic solvent medium;
(ii) depositing a layer of said sol formulation on the surface of said support; and
(iii) drying the layer formed in step (ii) so as to obtain said silica-based sol-gel matrix.

15. The process as claimed in claim 1, in which doped tungsten bronze nanocrystals, are previously prepared by:
bottom-up synthesis of the nanocrystals from tungsten hexacarbonyl (W(CO)₆) and a precursor of the metal M.

16. The process as claimed in claim 14, in which the deposition in step (ii) of said sol formulation is performed by spin-coating, slot-die coating, dip-coating, blade-coating or spraying.

17. The process as claimed in claim 14, in which the drying in step (iii) is performed at a temperature of between 40° C. and 250° C.

18. A structure comprising at least one support, having on at least one of its faces a solar-control coating formed from a sol formulation as defined in claim 1.

19. The structure as claimed in claim 18, in which said solar-control coating has a thickness of between 10 nm and 25 μm.

20. The structure as claimed in claim 18, in which said solar-control coating has a volumetric fraction of doped tungsten bronze nanocrystals of between 0.1% and 30%.

21. The structure as claimed in claim 18, in which the distance between the doped tungsten bronze nanocrystals within said coating is strictly greater than 4 nm and less than or equal to 100 nm.

22. The structure as claimed in claim 18, the coating having a transmittance, over the entire visible spectrum, of greater than or equal to 70%.

23. The structure as claimed in claim 18, the coating having an NIR absorption percentage, noted A_{NIR}, of greater than or equal to 60%, and/or a solar energy transmission selectivity, known as “SETS”, of greater than or equal to 0.70.

24. The structure as claimed in claim 18, also comprising a protective layer on the surface of the solar-control coating.

25. An article comprising at least one structure as defined in claim 18.
